(19) United States
(12) Patent Application Publication
(10) Pub. No.: US 2025/0206963 A1
(43) Pub. Date: Jun. 26, 2025

(54) SURFACE TREATED STEEL SHEET AND METHOD OF PRODUCTION OF PART

(71) Applicant: NIPPON STEEL CORPORATION, Tokyo (JP)

(72) Inventors: Yasuaki KAWAMURA, Tokyo (JP); Takashi FUJII, Tokyo (JP); Kunihiko TOSHIN, Tokyo (JP); Kohei UEDA, Tokyo (JP); Daichi UEDA, Tokyo (JP)

(73) Assignee: NIPPON STEEL CORPORATION, Tokyo (JP)

(21) Appl. No.: 18/852,310

(22) PCT Filed: Mar. 30, 2023
(86) PCT No.: PCT/JP2023/013380

§ 371 Date: Sep. 27, 2024

(30) Foreign Application Priority Data
Mar. 31, 2022 (JP) 2022-060402

(51) Int. Cl. C09D 5/24; C08K 3/22; C08K 9/02; C09D 5/00; C09D 5/08; C09D 7/62; C09D 161/04; C25D 5/36

(52) U.S. Cl. CPC C09D 5/24; C09D 5/002; C09D 5/084; C09D 7/62; C09D 161/04; C25D 5/36; C08K 2003/222; C08K 2003/2224; C08K 9/02

(57) ABSTRACT

A surface treated steel sheet excellent in weldability and corrosion resistance after electrodeposition coating is disclosed. The surface treated steel sheet of the present disclosure has a plated steel sheet having a Zn-containing plated layer and a surface treatment layer provided on at least one main surface of the plated steel sheet, wherein the surface treatment layer has at least a paint film as an outer layer, the paint film has an average film thickness of 0.5 μm or more and 5.0 μm or less, the paint film includes a binder resin, rust preventer, and conductive agent, and the binder resin includes a phenolic resin with a cross-linking degree of 40% or more or 80% or less.

### FIELD

The present application discloses a surface treated steel sheet and a method of production of a part.

### BACKGROUND

Surface treated steel sheet is used as a component material of automobiles etc. Surface treated steel sheet has for example a plated steel sheet having a Zn-containing plated layer and a surface treatment layer provided on at least one main surface of that plated steel sheet. In the prior art, a paint film is employed as the surface treatment layer and the types or contents of the constituents forming the paint film are adjusted to improve the weldability and corrosion resistance of the surface treated steel sheet.

For example, PTL 1 discloses a surface treated steel sheet comprised of a plated steel sheet on at least one surface of which a paint film is formed, in which paint film, a binder resin, nonoxide ceramic particles containing V, and doped zinc oxide particles are included in predetermined amounts to thereby improve the weldability and corrosion resistance of the surface treated steel sheet.

Further, PTL 2 discloses a coated steel sheet comprised of a Zn-containing plated steel sheet on at least one surface of which two or more layers of paint film are formed, in which an outermost layer of the paint film is made a predetermined thickness, the outermost layer of the paint film is made to contain a predetermined nonchromium compound, and the composition of the paint film is designed so that an electroconductivity of an immersion solution becomes the 30 μS/cm or more when immersing the coated steel sheet in an ion exchange solution under predetermined conditions, to thereby improve the corrosion resistance of the end faces of the coated steel sheet.

Further, PTL 3 discloses a coated metal material comprised of a metal material on the surface of which an organic film is provided, in which the organic film is made to contain a predetermined resin having urethane bonds and predetermined conductive particles to thereby improve the weldability and corrosion resistance of the coated metal material.

Further, PTL 4 discloses a covered metal sheet comprised of a metal sheet on the surface of which a covering layer is provided, in which the covering layer is made to contain conductive particles of a predetermined particle size to thereby improve the weldability and corrosion resistance of the covered metal sheet.

### CITATIONS LIST

### Patent Literature

[PTL 1] WO2018/092244
[PTL 2] Japanese Unexamined Patent Publication No. 2012-136025
[PTL 3] Japanese Unexamined Patent Publication No. 2004-042622
[PTL 4] Japanese Unexamined Patent Publication No. 2004-183080

### SUMMARY

### Technical Problem

The surface treated steel sheet used as a component material of automobiles etc. is required to have not only the above such weldability and corrosion resistance, but also paint film adhesion after electrodeposition coating. For example, as a test for evaluating the paint film adhesion after electrodeposition coating, there is the warm salt dipping test (SDT). According to new discoveries of the inventors, if running an SDT on a conventional surface treated steel sheet after electrodeposition coating, blisters and peeling of paint film occur at the surface after the SDT. If blisters or peeling of the paint film occurs at the surface treated steel sheet, they become a cause of red rust etc. and sufficient corrosion resistance is difficult to secure. In conventional surface treated steel sheet, suppression the occurrence of blisters and peeling of the paint film in the SDT and raising the corrosion resistance after SDT has not been sufficiently studied. As explained above, new art enabling achievement of both weldability and corrosion resistance of the surface treated steel sheet and paint film adhesion after electrodeposition coating is required.

### Solution to Problem

The present application discloses the following aspects as means for solving the above problem.

### [Aspect 1]

A surface treated steel sheet comprising:
a plated steel sheet having a Zn-containing plated layer; and
a surface treatment layer provided on at least one main surface of the plated steel sheet,
wherein
the surface treatment layer has at least a paint film as an outer layer,
the paint film has an average film thickness of 0.5 μm or more and 5.0 μm or less,
the paint film includes a binder resin, rust preventer, and conductive agent, and
the binder resin includes a phenolic resin with a cross-linking degree of 40% or more and 80% or less.

### [Aspect 2]

The surface treated steel sheet according to the aspect 1, wherein
the surface treated steel sheet is for electrodeposition coating.

### [Aspect 3]

The surface treated steel sheet according to the aspect 1 or 2, wherein
the conductive agent includes doped oxide particles and
the paint film includes the doped oxide particles in 5 vol % or more and 30 vol % or less.

### [Aspect 4]

The surface treated steel sheet according to the aspect 3, wherein
the doped oxide particles are doped zinc oxide particles.

### [Aspect 5]

The surface treated steel sheet according to any one of the aspects 1 to 4, wherein
the rust preventer includes at least one magnesium compound among magnesium hydroxide and magnesium oxide, and
the paint film contains the magnesium compound in 5 vol % or more and 15 vol % or less.

### [Aspect 6]

The surface treated steel sheet according to any one of the aspects 1 to 5, wherein
the surface treatment layer has an inorganic based or organic/inorganic composite based film as an inner layer between the paint film and the plated steel sheet, and
the inorganic based or organic/inorganic composite film has an average film thickness of 0.1 μm or more and 1.0 μm or less.

### [Aspect 7]

A method of production of a part, the method comprising:
preparing a surface treated steel sheet according to any one of aspects 1 to 6; and
placing the outermost layer on the surface of the paint film of the surface treated steel sheet, then heating it to make the phenolic resin cross-link and bond the paint film and the outermost layer.

### [Aspect 8]

The method of production according to the aspect 7, the method comprising:
placing an electrodeposition coating film as the outermost layer on the surface of the paint film.

### Advantageous Effects of Invention

The surface treated steel sheet of the present disclosure is excellent in weldability, corrosion resistance, and paint film adhesion after electrodeposition coating. For example, the occurrence of blisters and peeling of the paint film in the SDT is suppressed and excellent corrosion resistance is given even after the SDT.

### DESCRIPTION OF EMBODIMENTS

Below, embodiments of the present invention will be explained. Note that the explanations of these are intended as just illustrations of the embodiments of the present invention. The present invention is not limited to the following embodiments.

### 1. Surface Treated Steel Sheet

The surface treated steel sheet according to an embodiment has a plated steel sheet having a Zn-containing plated layer and a surface treatment layer provided on at least one main surface of the plated steel sheet. The surface treatment layer has at least a paint film as an outer layer. The paint film has an average film thickness of 0.5 μm or more and 5.0 μm or less. The paint film includes a binder resin, rust preventer, and conductive agent. The binder resin includes a phenolic resin with a cross-linking degree of 40% or more or 80% or less.

### 1.1 Plated Steel Sheet

The plated steel sheet, for example, has a base steel sheet and a Zn-containing plated layer provided on at least one main surface of the base steel sheet. A “main surface” referred to in the present application is a surface corresponding to the front surface or back surface of the sheet. The Zn-containing plated layer may be provided on only one main surface of the base steel sheet or may be provided on both main surfaces. Further, the Zn-containing plated layer may be provided on an entire main surface of the base steel sheet or may be provided on part of a main surface.

As the base steel sheet, ones having various chemical compositions and metallographic structures can be employed. The base steel sheet may be an ordinary steel sheet or may be a steel sheet containing chromium and other added elements. The targeted mechanical properties, shapeability, etc. may be considered to adjust the chemical composition or metallographic structure of the base steel sheet. Further, the thickness of the base steel sheet is also not particularly limited. For example, it may be 0.2 mm or more or may be 6.0 mm or less.

The Zn-containing plated layer may be one having a chemical composition known to persons skilled in the art. For example, the Zn-containing plated layer may contain Al and other added elements in addition to Zn. Further, if alloying treatment is performed, Fe etc. may also be included. As one example, the Zn-containing plated layer may be a Zn—Al—Mg alloy plated layer containing at least Al and Mg or may be a Zn—Al—Mg—Si alloy plated layer further containing Si. The content (concentrations) of these elements may also be, by mass %, Al: 0 to 60%, Mg: 0 to 10%, Si: 0 to 2%, Mn: 0 to 1%, Ni: 0 to 1%, Sb: 0 to 1%, and Fe: 0 to 20%. The Zn-containing plated layer may also be a hot dip galvannealed layer, hot dip galvanized layer, or electrogalvanized layer. The amount of deposition of the Zn-containing plated layer on the base steel sheet is not particularly limited and may be a general amount of deposition. For example, the thickness of the Zn-based plated layer may be 1 to 30 μm.

### 1.2 Surface Treatment Layer

The surface treatment layer is provided on at least one main surface of the plated steel sheet. The surface treatment layer may be provided on only one main surface of the plated steel sheet or may be provided at both main surfaces. Further, the surface treatment layer may be provided on an entire main surface of the plated steel sheet or may be provided at part of a main surface. The surface treatment layer can be placed over the surface of the Zn-containing plated layer in the surface of the plated steel sheet.

The surface treatment layer has at least a paint film as its outer layer. The surface treatment layer may be comprised of only the paint film or may have a two-layer structure of a paint film as an outer layer and a chemical conversion coating film as an inner layer. If the surface treatment layer has this two-layer structure, a better corrosion resistance etc. can be exhibited. On the other hand, if the surface treatment layer does not have a chemical conversion coating film as an inner layer, a better spot weldability can be exhibited.

### 1.2.1 Paint Film

In the surface treated steel sheet according to the present embodiment, the paint film includes a binder resin, rust preventer, and conductive agent.

### (Binder Resin)

The binder resin includes a phenolic resin with a degree of cross-linking of 40% or more and 80% or less. By the paint film including a phenolic resin in the semi-cross-linked state, for example, it is possible to promote the cross-linking of the phenolic resin in the semi-cross-linked state by the heating in the electrodeposition coating, whereby the adhesion between the paint film and the electrodeposition coating film is improved. Alternatively, according to the surface treated steel sheet according to the present embodiment, it is possible to improve the adhesion between the outermost layer other than the electrodeposition coating film and the paint film. As the phenolic resin, any thermosetting one (for example, a resol type) can be employed. The type of phenols, aldehydes and catalyst forming the phenolic resin in the semi-cross-linked state is not particularly limited. Whatever the case, in the present embodiment, the degree of cross-linking of the phenolic resin need only be 40% or more and 80% or less. The degree of cross-linking of the phenolic resin is measured in the following way. That is, two pieces of predetermined sizes of the surface treated steel sheet are cut off by shears. One is designated as the Sample A and the remaining one is allowed to stand in an oven set to 200° C. for 1 hour, then cooled. This is designated as the Sample B. The two samples are used for FT-IR to find the transmittances (%) I_{A}, I_{B} of the hydroxy groups at 3200 to 3400 cm⁻¹ in the paint film. After that, the paint films of the Samples A and B are removed by resin shot blasting or a solvent etc., then the transmittances (%) I_{A0}, I_{B0} of the hydroxy groups at 3200 to 3400 cm of the steel sheet surface are found. ((I_{A0}−I_{A})/(I_{B0}−I_{B})×100) can be found as the “degree of cross-linking (%) of the phenolic resin”.

According to findings of the inventors, a phenolic resin, even in the above-mentioned semi-cross-linked state, can form a film excellent in hardness and adhesion and excellent in weldability. If using a resin other than a phenolic resin as the resin in the semi-cross-linked state, such an effect is difficult to obtain. For example, if using a polyester resin as the resin in the semi-cross-linked state, if pressing or otherwise working the surface treated steel sheet, the paint film tends to end up peeling off. Further, if using a polyester resin as the resin in the semi-cross-linked state, the paint film tends to become sticky and, for example, pressing and welding may become difficult.

The binder resin may contain other resins in addition to the above phenolic resins. As the other resins, various types of thermosetting resins and thermoplastic resins may be mentioned. For example, at least one type of resin selected from epoxy resins, polyester resins, urethane resins, acryl resins, nylon resins, and olefin resins may be mentioned. The epoxy resins may be aromatic epoxy resins, may be aliphatic epoxy resins, and may be amines and other epoxy resins. As specific examples of the epoxy resins, for example, bisphenol A type epoxy resins, bisphenol F type epoxy resins, hydrated bisphenol A type epoxy resins, brominated bisphenol A type epoxy resins, bisphenol S type epoxy resins, phenol novolac type epoxy resins, cresol novolac type epoxy resins, bisphenol A novolac type epoxy resins, biphenyl type epoxy resins, naphthalene type epoxy resins, dicyclopentadiene type epoxy resins, triphenylmethane type epoxy resins, etc. may be mentioned. The epoxy resins may be combined with curing agents. As the curing agents, phenolic resins and other various types of epoxy curing agents can be employed. If a polyester resin is employed as the binder resin, the polyester resin may be one having a glass transition temperature Tg of −20 to 70° C. and may be one having a number average molecular weight of 3000 to 30000. If an urethane resin is employed as the binder resin, the urethane resin may be one having a Tg of 0 to 50° C. and may be one having a number average molecular weight of 5000 to 25000. If an acryl resin is employed as the binder resin, the aryl resin may be one having a Tg of 0 to 50° C. and may be one having a number average molecular weight of 3000 to 25000. The binder resin may contain a curing agent other than an epoxy curing agent as well. For example, melamine resins, isocyanate resins, etc. can be employed.

The content of the binder resin in the paint film is not particularly limited. For example, it may be 50 vol % or more or 60 vol % or more and may be 90 vol % or less, 80 vol % or less, or 70 vol % or less. Further, the ratio of the phenolic resin in the binder resin is not particularly limited. Based on the binder resin as a whole as 100 vol %, the ratio of the phenolic resin may be 50 vol % or more, 60 vol % or more, 70 vol % or more, 80 vol % or more, or 90 vol % or more.

### (Rust Preventer)

The rust preventer may be an inorganic rust preventer or may be an organic rust preventer. The rust preventer, for example, may include at least one magnesium compound among magnesium hydroxide and magnesium oxide. In the present embodiment, by the paint film including a magnesium compound as a rust preventer, the corrosion resistance becomes much easier to improve. In this case, the content of the magnesium compound in the paint film is not particularly limited, but if the paint film contains a magnesium compound in 5 vol % or more and 15 vol % or less, a better corrosion resistance becomes easier to express. The content of the magnesium compound in the paint film may be 6 vol % or more, 7 vol % or more, or 8 vol % or more and may be 14 vol % or less, 13 vol % or less, or 12 vol % or less.

The rust preventer may contain, together with the above magnesium compounds or in place of the above magnesium compounds, at least one element among P and V as elements exhibiting a rust preventing function. As rust preventers containing P, for example, orthophosphoric acid, metaphosphoric acid, pyrophosphoric acid, triphosphoric acid, tetraphosphoric acid, and other phosphoric acids, triammonium phosphate, diammonium hydrogen phosphate, and other ammonium salts, metal phosphates with Na, Mg, Al, K, Ca, Mn, Ni, Zn, Fe, etc., aminotri(methylenephosphonic acid), 1-hydroxyethylidene-1,1-diphosphonic acid, ethylenediamine tetra(methylenephosphonic acid), diethylene triamine penta(methylenephosphonic acid), and other phosphonic acids and their salts, phytic acid, and other organic phosphoric acids and their salts, etc. may be mentioned. Further, as rust preventers containing V, vanadium pentoxide, metavanadic acid HVO₃, ammonium metavanadate, vanadium oxytrichloride VOCl₃, vanadium trioxide V₂O₃, vanadium dioxide, vanadium oxysulfate VOSO₄, vanadium oxyacetylacetonate VO(OC(═CH₂)CH₂COCH₃)₃, vanadium acetylacetonate V(OC(═CH₂)CH₂COCH₃)₃, vanadium trichloride VCl₃, etc. may be mentioned. Further, the rust preventer may be one containing a guanidino group-containing compound, p-guanidino group-containing compound, thiocarbonyl group-containing compound, etc. The rust preventer may be water soluble or may be water insoluble. If the rust preventer is water soluble, for example, when the paint film is exposed to a moist environment, the rust preventer may dissolve in the water and be eluted whereby a rust preventing function of inhibiting corrosion of the plated layer can be exhibited.

The form of the rust preventer may, for example, be granular. If the rust preventer is granular, the average particle diameter is not particularly limited. Ones of suitable sizes may be selected considering the thickness of the paint film etc. If the particle size of the rust preventer is too large for the thickness of the paint film, the rust preventer more easily sheds from the paint film. The average particle diameter of the rust preventer may be 1/10 or more or ⅕ or more of the thickness of the paint film and further may be 2 times or less or an equal ratio or less of the thickness of the paint film. The average particle diameter of the rust preventer is, for example, 0.1 μm or more, 0.3 μm or more, 0.5 μm or more, or 1.0 μm or more and, further, may be 20 μm or less, 10 μm or less, 8.0 μm or less, 6.0 μm or less, 5.0 μm or less, 4.0 μm or less, or 2.5 μm or less. The “average particle diameter” of the rust preventer means the average primary particle diameter if the particles present in the paint film are present as primary particles and means the average secondary particle diameter if they are present agglomerated. The average particle diameter is measured in the following way. That is, a surface treated steel sheet formed with a paint film is cut, and the cross-section is exposed, then polished. The thus obtained polished cross-section is examined by a scan type electron microscope to obtain an examined image. From the rust preventer particles present in the field of the examined image, several are arbitrarily selected. The circle equivalent diameters of these particles are found, and their average value is regarded as the “average particle diameter”. Whether the particles in the examined image are the rust preventer can be easily judged by elemental analysis etc.

The content of the rust preventer as a whole in the paint film is not particularly limited. For example, the content of the rust preventer as a whole in the paint film may be 5.0 vol % or more, 6 vol % or more, 7 vol % or more, or 8 vol % or more and may be 15 vol % or less, 14 vol % or less, 13 vol % or less, or 12 vol % or less.

### (Conductive Agent)

The conductive agent has the function of improving the conductivity of the paint film to improve the weldability of the surface treated steel sheet. In the present application, for example, an agent having a volume resistance of 1.0×10³ Ω/cm or less can become a conductive agent. As the conductive agent, for example, a metal or metal compound may be mentioned. Specifically, it may be magnesium, aluminum, silicon, calcium, scandium, titanium, vanadium, chromium, manganese, iron, cobalt, nickel, copper, zinc, gallium, germanium, strontium, yttrium, zirconium, niobium, molybdenum, technetium, ruthenium, rhodium, palladium, silver, cadmium, indium, tin, and other metals; alloys of magnesium, aluminum, silicon, phosphorus, calcium, scandium, titanium, vanadium, chromium, manganese, iron, cobalt, nickel, copper, zinc, gallium, germanium, arsenic, strontium, yttrium, zirconium, niobium, molybdenum, technetium, ruthenium, rhodium, palladium, silver, cadmium, indium, tin, antimony, tellurium, etc.; or oxides and other compounds of the above metal elements. Among these as well, magnesium, aluminum, silicon, chromium, iron, nickel, zinc, tin, zinc-aluminum alloys, zinc-aluminum-magnesium alloys, zinc-aluminum-magnesium-silicon alloys, zinc-iron alloys, zinc-chromium alloys, zinc-nickel alloys, iron-nickel alloys, iron-chromium alloys, stainless steel, ferrosilicon, ferromanganese, ferrophosphorus, zinc oxide, etc. are easy to obtain. The content of the conductive agent in the paint film is not particularly limited and may be suitably determined considering the targeted weldability and corrosion resistance.

In particular, if the conductive agent contains doped oxide particles, it can easily improve the corrosion resistance along with the conductivity. In this case, the paint film may contain the doped oxide particles in 5 vol % or more and 30 vol % or less. Alternatively, the conductive agent may also be a Si alloy containing 50 mass % or more of Si, a Si compound containing 50 mass % or more of Si, or a composite of the same.

If the conductive agent contains doped oxide particles, as a specific example of the doped oxide particles, doped zinc oxide particles may be mentioned. As the doped zinc oxide particles, for example, at least one type of doping element selected from the group comprising B, Al, Ga, In, and other elements of Group XIII of the Periodic Table and P, As, and other Group XV elements of the Periodic Table which improve the conductivity by doping the zinc oxide particles may be mentioned. If the doping element is Al or Ga, the conductivity is improved more easily. The content of the doping element may be, for example, 0.05 atom % or more or 0.1 atom % or more and may be 5 atom % or less with respect to the nondoped zinc oxide particles.

If the conductive agent contains a Si alloy or Si compound, as a specific example of the Si alloy or Si compound, ferrosilicon containing 70 mass % or more of Si may be mentioned. By making the paint film include ferrosilicon as a conductive agent, the conductivity of the paint film and the corrosion resistance can be easily improved. In particular, ferrosilicon containing 70 mass % or more of Si is excellent in corrosion resistance and shapeability.

The conductive agent may, for example, be particles in form. If the conductive agent is comprised of particles in form, the average particle size is not particularly limited. An agent of a suitable size may be selected considering the thickness of the paint film etc. If the particle size of the conductive agent is too small compared with the thickness of the paint film, the conductivity easily falls. On the other hand, if the particle size of the conductive agent is too large compared with the thickness of the paint film, the conductive agent will easily shed from the paint film. On this point, the average particle diameter of the conductive agent may be 1/10 or more or ⅕ or more of the thickness of the paint film and, further, may be 2 times or less or equal in ratio or less. The average particle diameter of the conductive agent, for example, may be 0.1 μm or more, 0.3 μm or more, 0.5 μm or more, or 1.0 μm or more and, further, may be 20 μm or less, 10 μm or less, 8.0 μm or less, 6.0 μm or less, 5.0 μm or less, 4.0 μm or less, or 2.5 μm or less. The “average particle diameter” of the conductive agent means the average primary particle diameter if the particles present in the paint film are present as primary particles and means the average secondary particle diameter if they are present agglomerated. The average particle diameter is measured in the following way. That is, a surface treated steel sheet formed with a paint film is cut, and the cross-section is exposed, then polished. The thus obtained polished cross-section is examined by a scan type electron microscope to obtain an examined image. From the conductive particles present in the field of the examined image, several are arbitrarily selected. The circle equivalent diameters of these particles are found, and their average value is regarded as the “average particle diameter”. Whether the particles in the examined image are the conductive agent can be easily judged by elemental analysis etc.

The content of the rust preventer in the paint film is not particularly limited. For example, the content of the rust preventer in the paint film may be 5 vol % or more, 6 vol % or more, 7 vol % or more, or 8 vol % or more and may be 30 vol % or less, 25 vol % or less, 20 vol % or less, or 15 vol % or less.

### (Other Constituents)

The paint film may contain other constituents besides the constituents explained above. As the other constituents, various additives may be mentioned, such as ones designed to improve the creative appearance such as a bright pigment, lubricant, defoamer, thickener, etc. The contents of these other constituents in the paint film are not particularly limited.

### (Average Film Thickness)

In the present embodiment, the paint film has an average film thickness of 0.5 μm or more and 5.0 μm or less. If the paint film is too thin, a sufficient corrosion resistance may not be obtained. Further, the barrier property against steam may fall and water may easily dwell at the interface of the paint film and plating etc. when steam pressing and peeling is liable to occur. On the other hand, if the paint film is too thick, the spot weldability may fall. The average film thickness of the paint film may be 1.0 μm or more or 2.0 μm or more and may be 4.5 μm or less or 4.0 μm or less. The average film thickness of the paint film is measured as explained below. That is, a surface treated steel sheet formed with a paint film is cut, and the cross-section is exposed, then polished. The thus obtained polished cross-section is examined by a scan type electron microscope to obtain an examined image. The thickness of the paint film present in the field of the examined image is measured at 10 points or more at intervals of 1 μm in the planar direction of the plated steel sheet and the average value is regarded as the “average film thickness”. Alternatively, it is also possible to determine the density of the paint film from the constituents included in the paint film and then measure the weight of the paint film to identify the average film thickness of the paint film. In the present embodiment, the average film thickness identified by either method may be 0.5 μm or more and 5.0 μm or less.

### (Amount of Deposition)

The amount of deposition of the paint film is not particularly limited. For example, the amount of deposition of the paint film may be 2.0 g/m² or more, 3.5 g/m² or more, or 5.0 g/m² or more and may be 20 g/m² or less, 15 g/m² or less, or 10 g/m² or less. The amount of deposition of the paint film in the surface treated steel sheet can be measured by the weight method or cross-sectional examination. As measurement of the amount of deposition by the weight method, by using the method of measuring the initial weight of the steel sheet cut to a predetermined size, then using a solvent or a dedicated chemical able to dissolve the binder resin to remove the paint film or the method of using shot blasting using resin beads to remove the paint film, it is possible to measure the weight of the steel sheet after removal of the paint film and find the difference of the same.

### 1.2.2 Chemical Conversion Coating Film

In the surface treated steel sheet according to the present embodiment, the surface treatment layer may have an inorganic based or organic/inorganic composite based film as an inner layer between the paint film and the plated steel sheet. The film may have an average film thickness of 0.1 μm or more and 1.0 μm or less. The film can also be called a “chemical conversion coating film”. That is, the surface treatment layer may be one having a two-layer structure of a paint film as an outer layer and a chemical conversion coating film as an inner layer.

### (Component Constituents)

By providing a chemical conversion coating film as an inner layer at the surface of the plated steel sheet and, further, providing the above paint film at the surface of the chemical conversion coating film, the adhesion of the paint film on the plated steel sheet etc. are improved. The chemical conversion coating film may also be a layer not substantially containing chromium (chromate-free layer). As a chromate-free treatment solution used for chemical conversion, a silica-based treatment solution mainly comprised of liquid phase silica, gaseous phase silica, a silicate, etc., a zircon-based treatment solution mainly comprised of a zircon-based compound, and mixtures of these etc. may be mentioned. The chemical conversion coating film may also contain a binder resin. For example, the chemical conversion coating film may contain at least one type of resin illustrated as a binder resin able to form the above-mentioned paint film. The content of the binder resin in the chemical conversion coating film and the contents of the constituents other than the binder resin are not particularly limited. For example, the content of the binder resin in the chemical conversion coating film may be 0 vol % or more and 50 vol % or less. Further, the contents of the constituents other than the binder resin may be 50 vol % or more and 100 vol % or less. The chemical conversion coating film as the inner layer may be an inorganic based film including an inorganic constituent as a binder or an organic/inorganic composite based film. The chemical conversion coating film may also include various additives, such as ones designed to improve the creative appearance such as a bright pigment, lubricant, defoamer, thickener, etc. The contents of these other constituents in the chemical conversion coating film are not particularly limited.

### (Average Film Thickness)

The average film thickness of the chemical conversion coating film is not particularly limited. From the viewpoint of further improving the adhesion between the plated steel sheet and paint film, the viewpoint of further improving the corrosion resistance and weldability, etc., the average film thickness of the chemical conversion coating film may be 0.1 μm or more and 1.0 μm or less. The average film thickness of the chemical conversion coating film can be measured in the same way as the average film thickness of the paint film. That is, a surface treated steel sheet formed with a chemical conversion coating film is cut, and the cross-section is exposed, then polished. The thus obtained polished cross-section is examined by a scan type electron microscope to obtain an examined image. The thickness of the chemical conversion coating film present in the field of the examined image is measured at 10 points or more at intervals of 1 μm in the planar direction of the plated steel sheet and the average value is regarded as the “average film thickness”. Alternatively, it is also possible to determine the density of the chemical conversion coating film from the constituents included in the chemical conversion coating film and then measure the weight of the chemical conversion coating film to identify the average film thickness of the chemical conversion coating film.

### (Amount of Deposition)

In the surface treated steel sheet, the amount of deposition of the chemical conversion coating film is not particularly limited. For example, if the amount of deposition of the chemical conversion coating film is 200 mg/m² or more and 2000 mg/m² or less, the corrosion resistance of the surface treated steel sheet can be easily improved more. The amount of deposition of the chemical conversion coating film at the surface treated steel sheet can be measured by fluorescent X-rays and cross-sectional analysis. Specifically, a calibration line sheet is prepared for each chemical conversion. The chemical conversion sheet and the calibration line sheet are measured by fluorescent X-rays. The amount of deposition on the prepared chemical conversion sheet is calculated by the X-ray intensities of the elements contained and the X-ray intensity of the calibration line sheet.

### 1.3 Effects

As explained above, in the surface treated steel sheet according to the present embodiment, a phenolic resin in the semi-cross-linked state is contained in the paint film. Due to this, after that, the phenolic resin can be made to cross-link by the heating when performing the electrodeposition coating etc. That is, if providing the paint film with some sort of outermost layer (for example, electrodeposition coating film), it is possible to improve the adhesion between the paint film and the outermost layer. As a result, it is possible to suppress formation of blisters and peeling of the paint film in the SDT. Further, it is possible to secure excellent corrosion resistance even after the SDT. Furthermore, by the average film thickness of the paint film being constant or less, excellent weldability can be secured. In this way, the surface treated steel sheet according to the present embodiment is excellent in weldability, corrosion resistance, and paint film adhesion after electrodeposition coating. For example, excellent effects are exhibited when used for an electrodeposition coating.

Further, as explained above, in the surface treated steel sheet according to the present embodiment, by a phenolic resin being employed as the resin in the semi-cross-linked state, the paint film becomes hard and the adhesion excellent. Due to this, in the surface treated steel sheet according to the present embodiment, for example, a paint film excellent in scratch resistance can be formed. The surface treated steel sheet according to the present embodiment, for example, when evaluated for scratch resistance of the paint film using a hardness H pencil in accordance with JIS K5600, has no paint film defects caused at the scratched part. Further, no peeling of the paint film occurs. That is, the paint film of the surface treated steel sheet according to the present embodiment, for example, may have a scratch hardness by the pencil method prescribed in JIS K5600 May 4 of a hardness of H or more.

### 2. Method of Production of Surface Treated Steel Sheet

The above-mentioned surface treated steel sheet can, for example, be produced by the following method: That is, the method of production of a surface treated steel sheet may comprise
preparing a plated steel sheet having a zinc-containing plated layer and
painting at least one main surface of the plated steel sheet with a painting material containing a binder resin, rust preventer, and conductive agent to form a paint film.

Alternatively, the method of production of a surface treated steel sheet may comprise
preparing a plated steel sheet having a zinc-containing plated layer,
chemically converting at least one main surface of the plated steel sheet to form a chemical conversion coating film, and
painting the surface of the chemical conversion coating film with a painting material containing a binder resin, rust preventer, and conductive agent to form a paint film.

### 2.1. Preparation of Plated Steel Sheet

The plated steel sheet having a Zn-containing plated layer can, for example, be obtained through the steps of obtaining a slab by continuous casting, hot rolling the slab to obtain a hot rolled sheet, coiling the hot rolled sheet, cold rolling the hot rolled sheet to obtain a cold rolled sheet, annealing the cold rolled sheet, plating the annealed sheet, optionally skin pass rolling it, etc. The continuous casting conditions, hot rolling conditions, coiling conditions, cold rolling conditions, annealing conditions, and plating conditions may be conventionally known general conditions.

### 2.2. Chemical Conversion

In the method of production of the present disclosure, at least one main surface of the plated steel sheet obtained in the above way may be formed with a chemical conversion coating film as an inner layer. The chemical conversion can be performed by coating the various types of treatment solutions explained above on the steel sheet surface and drying them.

### 2.3. Formation of Paint Film

In the method of production of the present disclosure, the surface of the plated steel sheet obtained in the above way or the surface of the chemical conversion coating formed in the above explained way may be coated with a painting material including a binder resin, rust preventer, and conductive agent and dried to form a paint film as an outer layer. Here, the type of the rust preventer contained in the paint film, the content of the rust preventer, the thickness of the paint film, etc. can be adjusted to obtain the surface treated steel sheet according to the present embodiment. However, in the present embodiment, it is important that the phenolic resin contained in the paint film be in the semi-cross-linked state as explained above. In the method of production according to the present embodiment, for example, it is preferable to adjust the heating temperature and heating time in the production to obtain such a phenolic resin in the semi-cross-linked state.

### 3. Method of Production of Part

The art of the present disclosure also has aspects of a method of production of a part. That is, the method of production of a part of the present disclosure comprises
preparing the surface treated steel sheet of the present disclosure and
placing the outermost layer on the surface of the paint film of the surface treated steel sheet, then heating it to make the phenolic resin cross-link and bond the paint film and the outermost layer.

The type of the outermost layer need only be one in which it is bonded to the paint film by heating. Various ones can be employed. If placing an outermost layer on the paint film, due to the heating, in addition to the cross-linking of semicured phenolic resin in the paint film, a bonding reaction occurs between the semi-cross-linked phenolic resin and the resin end groups of the outermost layer whereby the adhesion between the paint film and outermost layer can be improved. In particular, as explained above, excellent effects are easy to obtain when placing an electrodeposition coating film as the outermost layer on the surface of the paint film. The electrodeposition coating conditions in this case (type of electrodeposition coating material, voltage, etc.) employed may be general conditions. In the method of production of the present disclosure, for example, after the surface treated steel sheet is coated by electrodeposition, the electrodeposition coating film is baked on whereby it is possible to make the phenolic resin in the semi-cross-linked state contained in the paint film of the surface treated steel sheet cross-link and a bonding reaction with the resin in the electrodeposition coating film can be obtained. Due to this, the adhesion of the paint film and electrodeposition coating film is improved. The baking temperature may, for example, be 150° C. or more and 190° C. or less and the baking time may, for example, be 10 minutes or more and 40 minutes or less.

The type of the part is not particularly limited. For example, it may be an electrodeposition coated part like explained above or may be another part.

### EXAMPLES

Below, the present invention will be explained further while providing examples, but the present invention is not limited to the following examples. The present invention can employ various conditions so long as not departing from the gist of the present invention and achieving the object of the present invention.

### 1. Production of Surface Treated Steel Sheet

### 1.1 Preparation of Hot Dip Galvannealed Steel Sheet

The following five types of zinc-based plated steel sheets and cold rolled steel sheet were prepared, dipped in an aqueous solution of a water-based alkali degreaser (FC-301 made by Nihon Parkerizing Co., Ltd.) (2.5 mass %, 40° C.) for 2 minutes to degrease the surfaces, then rinsed and dried to obtain the base metal sheets for surface treatment.
GA: Hot dip galvannealed steel sheet (sheet thickness 0.8 mm, 10 mass % Fe, plating deposition amount 45 g/m²)
ZA1: Zn—Al—Mg ternary hot dip galvanized steel sheet (Zn-11% Al-3% Mg-0.2% Si) (sheet thickness 0.8 mm, 10 mass % Fe, plating deposition amount 60 g/m²)
ZA2: Zn—Al—Mg ternary hot dip galvanized steel sheet (Zn-6% Al-3% Mg) (sheet thickness 0.8 mm, 10 mass % Fe, plating deposition amount 60 g/m²)
ZL: Electro Zn-10 mass % Ni alloy plated steel sheet (sheet thickness 0.8 mm, plating deposition amount 40 g/m²)
GI: Hot dip galvanized steel sheet (sheet thickness 0.8 mm, plating deposition amount 60 g/m²)
EG: Electrogalvanized steel sheet (sheet thickness 0.8 mm, plating deposition amount 40 g/m²)
CR: Cold rolled steel sheet (sheet thickness 0.8 mm, no plating)

### 1.2 Formation of Inner Layer (Chemical Conversion Coating Film)

Next, the following treatment solution S for chemical conversion use is prepared. The treatment solution is coated on the above-mentioned base metal sheet while changing the diameter of the bar coater. After that, the sheet was dried in a hot air oven until the peak temperature at the metal sheet surface became 70° C. It was then air dried to form a chemical conversion coating film on the surface of the metal sheet. The average film thickness of the chemical conversion coating film was 0.2 μm.

S: Treatment solution for chemical conversion use of Nv10% comprised of a Zr compound, silane coupling agent, silica fine particles, and a polyester resin

### 1.3 Formation of Outer Layer (Paint Film)

Next, a paint film having each of the compositions (vol %) shown in Table 1 was formed by mixing the constituents so as to obtain a solids concentration similar to Table 1 to thereby prepare a painting composition for formation of a paint film. The resin composition was coated on the base metal sheet or on the chemical conversion coating film while changing the diameter of the bar coater or dilution rate and the sheet was dried using an oven under conditions giving a peak maximum temperature (PMT) of 140° C., 160° C., 180° C., or 200° C. to thereby form a paint film as an outer layer. Here, the peak maximum temperature at the time of drying was used to adjust the degree of cross-linking of the phenolic resin in the paint film. The average film thickness of the paint film was the thickness shown in Table 2 (μm). Further, the constituents included in the paint composition are shown below:

### (Rust Preventing Pigment)

MgO: Magnesium oxide (average particle diameter 3 μm)
Mg(OH)₂: Magnesium hydroxide (average particle diameter 3 μm)
PA: Ammonium tripolyphosphate (amount of oil absorption 10 ml/100 g, particle diameter 2 μm)

### (Conductivity Pigment)

ZnO: Doped zinc oxide particles (23-Kt made by Hakusuitec, average particle diameter 0.5 μm)
FeSi: Ferrosilicon particles (average particle diameter 3 μm, containing 70 mass % or more of Si)
SUS: SUS particles (average particle diameter 5 μm) (Binder Resin)
B1: Phenolic resin (water-based resol type phenolic resin GG-1490 made by DIC)
B2: Phenolic resin (resol type phenolic resin 5010 made by DIC)
B3: Urethane resin (Superflex 150 made by DKS Co., Ltd.)
B4: Polyester resin (Vylonal MD1480 made by Vylon)
B5: Melamine resin (Cymel 325 made by allnex)

### 2. Tests for Evaluation of Performance

The surface treated steel sheets were subjected to the following tests for evaluation of performance.

### 2.1 Measurement of Degree of Cross-Linking

If using a phenolic resin as the binder in the paint film, the degree of cross-linking of the phenolic resin included in the paint film was measured as follows. The results are shown in Table 2.

### (Method of Measurement of Degree of Cross-Linking of Phenolic Resin)

Two pieces of predetermined sizes of the surface treated steel sheet fabricated as explained above were cut off by shears. One was designated as the Sample A and the remaining one was allowed to stand in an oven set to 200° C. for 1 hour, then cooled. This was designated as the Sample B. The two samples were used for FT-IR to find the transmittances (%) I_{A}, I_{B} of the hydroxy groups at 3200 to 3400 cm⁻¹ in the paint film. After that, the paint films of the Samples A and B were removed by resin shot blasting or a solvent etc., then the transmittances (%) I_{A0}, I_{B0} of the hydroxy groups at 3200 to 3400 cm⁻¹ of the steel sheet surface were found. ((I_{A0}−I_{A})/(I_{B0}−I_{B})×100) was measured as the “degree of cross-linking (%) of the phenolic resin”.

### 2.2 Warm Salt Dipping Test (SDT)

### (Advance Preparations)

Each surface treated steel sheet was conditioned on its surface at room temperature for 20 seconds using a surface conditioning treatment agent “PREPALENE-X (product name)” made by Nihon Parkerizing Co., Ltd. Further, it was chemically converted (phosphate treatment) using a chemical conversion solution (zinc phosphate treatment solution) “Palbond 3020 (product name)” made by Nihon Parkerizing Co., Ltd. The temperature of the chemical conversion solution was made 43° C. The hot pressed material was dipped in the chemical conversion solution for 120 seconds, then rinsed and dried. After the above chemical conversion treatment (phosphate treatment), a cationic electrodeposition coating made by Nippon Paint Co., Ltd. was deposited by electrodeposition by slope energization of a voltage of 160V and further was baked on by a baking temperature of 170° C. for 20 minutes. The average of the thickness of the electrodeposition coating film after the electrodeposition coating was 10 μm in all samples.

### (Corrosion Resistance at SDT (Blister Area Ratio))

After the above electrodeposition coating, the end faces of the surface treated steel sheet were sealed by tape and the sheet was immersed in a 3% NaCl aqueous solution having a 50° C. temperature for 500 hours. The sample taken out after the immersion test was dried and visually measured for the area ratio of blisters present at the electrodeposition coating film. In the corrosion resistance test, in the case of “3”, it was judged that a certain extent of corrosion resistance was possessed while in the case of “4” or “5”, it was judged that the corrosion resistance was excellent. The results are shown in Table 2.
1: Blister area ratio from evaluated surface of 50% or more
2: Blister area ratio from evaluated surface of 5% or more and less than 50%
3: Blister area ratio from evaluated surface of 1% or more and less than 5%
4: Blisters formed from evaluated surface, but less than 1%
5: No blisters formed

### 2.3 Post SDT Corrosion Resistance Test

Each surface treated steel sheet coated by electrodeposition after the warm salt dipping test was subjected to a cycle corrosion test under the following cycle conditions for 120 cycles.

### (Cycle Conditions)

A salt spray test (SST, 5% NaCl, 35° C. atmosphere) was conducted for 2 hr, with drying (60° C.) for 2 hr, and wetting (50° C., 98% RH) for 4 hr as 1 cycle.

After that, the state of corrosion was examined from a flat part and the following evaluation points were assigned. In the corrosion resistance test, in the case of “3”, “4”, or “5”, the corrosion resistance was judged to be excellent. The results are shown in Table 2.
1: White rust area ratio from evaluated surface of 50% or more or red rust confirmed to occur from evaluated surface
2: White rust area ratio from evaluated surface of 10% or more and less than 50%
3: White rust area ratio from evaluated surface of 5% or more and less than 10%
4: White rust area ratio from evaluated surface of 1% or more and less than 5%
5: White rust area ratio from evaluated surface of less than 1%

### 2.4 Spot Weldability

Each surface treated steel sheet was subjected to an electrode life test of spot welding using R40 CF type Cr—Cu electrodes with a tip diameter of 5 mm at a clamping force of 1.96 kN, weld current of 8 kA, and weld time of 12 cycles/50 Hz. The number of welds until right before the nugget size became less than 3√t (“t” is sheet thickness) was found. The level of the spot weldability was evaluated using the following evaluation points. In the weldability test, in the case of “4”, “5”, or “6”, the weldability was judged to be excellent. The results are shown in Table 2.
1: Nugget not formed and not even one point could be welded or number of welds of less than 10
2: Number of welds of 10 or more and less than 50
3: Number of welds of 50 or more and less than 200
4: Number of welds of 200 or more and less than 1000
5: Number of welds of 1000 or more and less than 2000
6: Number of welds of 2000 or more

### 2.5 Scratch Hardness

Using a hardness H pencil made by Mitsubishi Pencil Co., Ltd., a scratch hardness test was conducted in accordance with JIS K5600 on the paint film of each surface treated steel sheet. The state of the paint film after scratching was examined and the scratch hardness was evaluated using the following evaluation points. In the scratch hardness test, in the case of “2” or “3”, the scratch hardness was judged to be excellent. The results are shown in Table 2.
1: Peeling occurred at part or all of scratched part
2: Paint film blemished, but no peeling of paint film at scratched part
3: No blemish of paint film at scratched part

TABLE 1

| | | | | | Rust preventing pigment | | | | Conductivity pigment | | | |
|---|---|---|---|---|---|---|---|---|---|---|---|---|
| | Binder resin | | | | Rust preventing | | Rust preventing | | Conductivity | | Conductivity | |
| | Resin 1 | | Resin 2 | | pigment 1 | | pigment 2 | | pigment 1 | | pigment 2 | |
| No | Type | Ratio | Type | Ratio | Type | Ratio | Type | Ratio | Type | Ratio | Type | Ratio |
| 1 | B1 | 70 | | | MgO | 10 | | | ZnO | 20 | | |
| 2 | B1 | 75 | | | MgO | 5 | | | ZnO | 20 | | |
| 3 | B1 | 65 | | | MgO | 15 | | | ZnO | 20 | | |
| 4 | B1 | 85 | | | MgO | 10 | | | ZnO | 5 | | |
| 5 | B1 | 80 | | | MgO | 10 | | | ZnO | 10 | | |
| 6 | B1 | 75 | | | MgO | 10 | | | ZnO | 15 | | |
| 7 | B1 | 60 | | | MgO | 10 | | | ZnO | 30 | | |
| 8 | B1 | 70 | | | MgO | 5 | Mg(OH)₂ | 5 | ZnO | 20 | | |
| 9 | B1 | 65 | | | MgO | 5 | Mg(OH)₂ | 10 | ZnO | 20 | | |
| 10 | B1 | 70 | | | Mg(OH)₂ | 10 | | | ZnO | 20 | | |
| 11 | B1 | 65 | | | MgO | 10 | PA | 5 | ZnO | 20 | | |
| 12 | B1 | 65 | | | PA | 15 | | | ZnO | 20 | | |
| 13 | B1 | 80 | | | None | | | | ZnO | 20 | | |
| 14 | B1 | 90 | | | MgO | 10 | | | None | | | |
| 15 | B2 | 70 | | | MgO | 10 | | | ZnO | 20 | | |
| 16 | B2 | 70 | | | MgO | 10 | | | FeSi | 20 | | |
| 17 | B2 | 60 | | | MgO | 10 | | | ZnO | 20 | SUS | 10 |
| 18 | B2 | 60 | | | MgO | 10 | | | FeSi | 20 | SUS | 10 |
| 19 | B3 | 70 | | | MgO | 10 | | | ZnO | 20 | | |
| 20 | B1 | 60 | B2 | 10 | MgO | 10 | | | ZnO | 20 | | |
| 21 | B1 | 55 | B2 | 15 | MgO | 10 | | | ZnO | 20 | | |
| 22 | B1 | 50 | B2 | 20 | MgO | 10 | | | ZnO | 20 | | |
| 23 | B4 | 70 | | | MgO | 10 | | | ZnO | 20 | | |
| 24 | B4 | 60 | B5 | 10 | MgO | 10 | | | ZnO | 20 | | |

TABLE 2

| | | | | | | | | Degree | | | | | |
|---|---|---|---|---|---|---|---|---|---|---|---|---|---|
| | | Chemical | | | | | | of cross- | | Warm | | | |
| | | Conversion | | | | | Coating | linking | | salt water | | | |
| | Steel | coating | | PMT/ | Heating | Coating | film | of binder | | corrosion | Weld- | Scratch | |
| | type | Yes/no | Thickness | ° C. | time/s | no. | thickness | resin/% | Blisters | resistance | ability | hardness | Remarks |
| 1 | GA | Yes | 0.2 | 160 | 20 | 1 | 2.0 | 60 | 4 | 4 | 4 | 3 | Ex. |
| 2 | GA | Yes | 0.2 | 160 | 20 | 2 | 2.0 | 60 | 4 | 3 | 4 | 3 | Ex. |
| 3 | GA | Yes | 0.2 | 160 | 20 | 3 | 2.0 | 60 | 4 | 4 | 4 | 3 | Ex. |
| 4 | GA | Yes | 0.2 | 160 | 20 | 4 | 2.0 | 60 | 4 | 4 | 3 | 3 | Ex. |
| 5 | GA | Yes | 0.2 | 160 | 20 | 5 | 2.0 | 60 | 4 | 4 | 3 | 3 | Ex. |
| 6 | GA | Yes | 0.2 | 160 | 20 | 6 | 2.0 | 60 | 4 | 4 | 4 | 3 | Ex. |
| 7 | GA | Yes | 0.2 | 160 | 20 | 7 | 2.0 | 60 | 4 | 3 | 5 | 3 | Ex. |
| 8 | GA | Yes | 0.2 | 160 | 20 | 8 | 2.0 | 60 | 4 | 4 | 4 | 3 | Ex. |
| 9 | GA | Yes | 0.2 | 160 | 20 | 9 | 2.0 | 60 | 4 | 4 | 4 | 3 | Ex. |
| 10 | GA | Yes | 0.2 | 160 | 20 | 10 | 2.0 | 60 | 4 | 4 | 4 | 3 | Ex. |
| 11 | GA | Yes | 0.2 | 160 | 20 | 11 | 2.0 | 60 | 4 | 4 | 4 | 3 | Ex. |
| 12 | GA | Yes | 0.2 | 160 | 20 | 12 | 2.0 | 60 | 4 | 3 | 4 | 3 | Ex. |
| 13 | GA | Yes | 0.2 | 160 | 20 | 13 | 2.0 | 60 | 3 | 2 | 4 | 3 | Comp. |
| | | | | | | | | | | | | | ex. |
| 14 | GA | Yes | 0.2 | 160 | 20 | 14 | 2.0 | 60 | 4 | 2 | 2 | 3 | Comp. |
| | | | | | | | | | | | | | ex. |
| 15 | GA | Yes | 0.2 | 160 | 20 | 15 | 2.0 | 60 | 4 | 4 | 4 | 3 | Ex. |
| 16 | GA | Yes | 0.2 | 160 | 20 | 16 | 2.0 | 60 | 4 | 4 | 5 | 3 | Ex. |
| 17 | GA | Yes | 0.2 | 160 | 20 | 17 | 2.0 | 60 | 4 | 4 | 4 | 3 | Ex. |
| 18 | GA | Yes | 0.2 | 160 | 20 | 18 | 2.0 | 60 | 4 | 4 | 5 | 3 | Ex. |
| 19 | GA | Yes | 0.2 | 160 | 20 | 19 | 2.0 | — | 2 | 2 | 4 | 2 | Comp. |
| | | | | | | | | | | | | | ex. |
| 20 | GA | Yes | 0.2 | 160 | 20 | 20 | 2.0 | 60 | 4 | 4 | 4 | 3 | Ex. |
| 21 | GA | Yes | 0.2 | 160 | 20 | 21 | 2.0 | 60 | 4 | 4 | 4 | 3 | Ex. |
| 22 | GA | Yes | 0.2 | 160 | 20 | 22 | 2.0 | 60 | 3 | 3 | 4 | 3 | Ex. |
| 23 | GA | Yes | 0.2 | 160 | 20 | 1 | 0.2 | 60 | 3 | 2 | 5 | 3 | Comp. |
| | | | | | | | | | | | | | ex. |
| 24 | GA | Yes | 0.2 | 160 | 20 | 1 | 0.5 | 60 | 3 | 3 | 5 | 3 | Ex. |
| 25 | GA | Yes | 0.2 | 160 | 20 | 1 | 1.0 | 60 | 4 | 3 | 5 | 3 | Ex. |
| 26 | GA | Yes | 0.2 | 160 | 20 | 1 | 3.0 | 60 | 5 | 4 | 4 | 3 | Ex. |
| 27 | GA | Yes | 0.2 | 160 | 20 | 1 | 5.0 | 60 | 5 | 5 | 3 | 2 | Ex. |
| 28 | GA | Yes | 0.2 | 160 | 20 | 1 | 10.0 | 60 | 4 | 4 | 2 | 2 | Comp. |
| | | | | | | | | | | | | | ex. |
| 29 | ZA1 | Yes | 0.2 | 160 | 20 | 1 | 2.0 | 60 | 4 | 5 | 3 | 3 | Ex. |
| 30 | ZA2 | Yes | 0.2 | 160 | 20 | 1 | 2.0 | 60 | 4 | 5 | 3 | 3 | Ex. |
| 31 | ZL | Yes | 0.2 | 160 | 20 | 1 | 2.0 | 60 | 4 | 4 | 4 | 3 | Ex. |
| 32 | GI | Yes | 0.2 | 160 | 20 | 1 | 2.0 | 60 | 4 | 3 | 4 | 3 | Ex. |
| 33 | EG | Yes | 0.2 | 160 | 20 | 1 | 2.0 | 60 | 4 | 3 | 4 | 3 | Ex. |
| 34 | CR | Yes | 0.2 | 160 | 20 | 1 | 2.0 | 60 | 4 | 1 | 4 | 3 | Comp. |
| | | | | | | | | | | | | | ex. |
| 35 | GA | No | — | 160 | 20 | 1 | 2.0 | 60 | 3 | 3 | 5 | 3 | Ex. |
| 36 | GA | Yes | 0.1 | 160 | 20 | 1 | 2.0 | 60 | 4 | 3 | 4 | 3 | Ex. |
| 37 | GA | Yes | 0.5 | 160 | 20 | 1 | 2.0 | 60 | 4 | 4 | 4 | 3 | Ex. |
| 38 | GA | Yes | 1 | 160 | 20 | 1 | 2.0 | 60 | 4 | 5 | 3 | 3 | Ex. |
| 39 | GA | Yes | 0.2 | 140 | 20 | 1 | 2.0 | 40 | 5 | 5 | 4 | 2 | Ex. |
| 40 | GA | Yes | 0.2 | 180 | 20 | 1 | 2.0 | 80 | 3 | 3 | 4 | 3 | Ex. |
| 41 | GA | Yes | 0.2 | 200 | 20 | 1 | 2.0 | 85 | 3 | 2 | 4 | 3 | Comp. |
| | | | | | | | | | | | | | ex. |
| 42 | GA | Yes | 0.2 | 220 | 20 | 1 | 2.0 | 95 | 2 | 2 | 4 | 3 | Comp. |
| | | | | | | | | | | | | | ex. |
| 43 | GA | Yes | 0.2 | 180 | 60 | 1 | 2.0 | 85 | 3 | 2 | 4 | 3 | Comp. |
| | | | | | | | | | | | | | ex. |
| 44 | GA | Yes | 0.2 | 180 | 240 | 1 | 2.0 | 90 | 2 | 2 | 4 | 3 | Comp. |
| | | | | | | | | | | | | | ex. |
| 45 | GA | Yes | 0.2 | 50 | 1200 | 1 | 2.0 | 20 | 2 | 2 | 3 | 1 | Comp. |
| | | | | | | | | | | | | | ex. |
| 46 | GA | Yes | 0.2 | 160 | 20 | 23 | 2.0 | 0 | 1 | 1 | 2 | 1 | Comp. |
| | | | | | | | | | | | | | ex. |
| 47 | GA | Yes | 0.2 | 160 | 20 | 24 | 2.0 | 50 | 2 | 2 | 2 | 1 | Comp. |
| | | | | | | | | | | | | | ex. |

### 3. Results and Considerations

From the results shown in Tables 1 and 2, the following will be understood.

In No. 13, the paint film did not contain a rust preventing pigment, so the corrosion resistance after the SDT was inferior.

In No. 14, the paint film did not contain a conductivity pigment, so the spot weldability was inferior.

In No. 19, the binder forming the paint film was not a phenolic resin, so blisters occurred at the time of the SDT and also the corrosion resistance after the SDT was inferior.

In No. 23, the thickness of the paint film was 0.2 μm or too thin, so the corrosion resistance after the SDT was inferior.

In No. 28, the thickness of the paint film was 10 μm or too thick, so the spot weldability was inferior.

In No. 34, steel sheet having a Zn-containing plated layer was used, so the corrosion resistance after the SDT was inferior.

In each of Nos. 41 to 44, while a phenolic resin was used as the binder forming the paint film, the degree of cross-linking of the phenolic resin was too high, so it was not possible to promote the cross-linking of the phenolic resin at the time of the electrodeposition coating and the adhesion of the paint film and electrodeposition coating film was inferior. For this reason, blisters formed at the time of the SDT and also the corrosion resistance after the SDT was inferior.

In No. 45, the degree of cross-linking of the phenolic resin in the paint film was 20% or too low, so the hardness of the paint film and the adhesion did not become sufficient.

In No. 46, a non-cross-linked polyester resin was used, so the hardness of the paint film and the adhesion did not become sufficient. Further, at the time of welding, the electrodes ended up sticking to the paint film so suitable welding was not possible. Further, in the scratch test, peeling of the paint film occurred.

In No. 47, a polyester resin was used as the semi-cross-linked resin in the paint film and a melamine resin was used as the cross-linking agent, so the adhesion of the paint film was insufficient. Further, at the time of welding, the electrodes ended up sticking to the paint film so suitable welding was not possible. Further, in the scratch test, peeling of the paint film occurred.

As opposed to this, in each of Nos. 1 to 12, 15 to 18, 20 to 22, 24 to 27, 29 to 33, and 35 to 40, almost no blisters formed at the time of the SDT, the corrosion resistance after the SDT was also excellent, and the spot weldability and scratch resistance were also excellent. In each of Nos. 1 to 12, 15 to 18, 20 to 22, 24 to 27, 29 to 33, and 35 to 40, the surface treated steel sheet (1) had a plated steel sheet having a Zn-containing plated layer, (2) the paint film of the surface treatment layer had a 0.5 μm or more and 5.0 μm or less average film thickness, (3) the paint film contained a binder resin, rust preventing pigment, and conductivity pigment, and (4) the binder resin included a phenolic resin with a degree of cross-linking of 40% or more and 80% or less. That is, it is believed that by the paint film including the rust preventing pigment and conductivity pigment, the corrosion resistance and spot weldability were improved. Further, it is believed that by a phenolic resin in the semi-cross-linked state being used as the binder resin, it was possible to promote the cross-linking of the phenolic resin by heating at the time of electrodeposition coating and the adhesion between the paint film and electrodeposition coating film was improved. Further, it is believed that by employing a phenolic resin as the semi-cross-linked resin in the paint film, the paint film became hard and excellent in adhesion and the scratch resistance was improved.

From the above results, a surface treated steel sheet satisfying the following requirements can be said to have excellent weldability and corrosion resistance.

A surface treated steel sheet comprising:
a plated steel sheet having a Zn-containing plated layer; and
a surface treatment layer provided on at least one main surface of the plated steel sheet,
wherein
the surface treatment layer has at least a paint film as an outer layer,
the paint film having a 0.5 μm or more and 5.0 μm or less average film thickness,
the paint film including a binder resin, rust preventer, and conductive agent,
the binder resin being a phenolic resin with a cross-linking degree of 40% or more or 80% or less.

1. A surface treated steel sheet comprising:
a plated steel sheet having a Zn-containing plated layer; and
a surface treatment layer provided on at least one main surface of the plated steel sheet,
wherein
the surface treatment layer has at least a paint film as an outer layer,
the paint film has an average film thickness of 0.5 μm or more and 5.0 μm or less,
the paint film includes a binder resin, rust preventer, and conductive agent, and
the binder resin includes a phenolic resin with a cross-linking degree of 40% or more and 80% or less.

2. The surface treated steel sheet according to claim 1, wherein
the surface treated steel sheet is for electrodeposition coating.

3. The surface treated steel sheet according to claim 1, wherein
the conductive agent includes doped oxide particles and
the paint film includes the doped oxide particles in 5 vol % or more and 30 vol % or less.

4. The surface treated steel sheet according to claim 3, wherein
the doped oxide particles are doped zinc oxide particles.

5. The surface treated steel sheet according to claim 1, wherein
the rust preventer includes at least one magnesium compound among magnesium hydroxide and magnesium oxide, and
the paint film contains the magnesium compound in 5 vol % or more and 15 vol % or less.

6. The surface treated steel sheet according to claim 1, wherein
the surface treatment layer has an inorganic based or organic/inorganic composite based film as an inner layer between the paint film and the plated steel sheet, and
the inorganic based or organic/inorganic composite film has an average film thickness of 0.1 μm or more and 1.0 μm or less.

7. A method of production of a part, the method comprising:
preparing a surface treated steel sheet according to claim 1; and
placing the outermost layer on the surface of the paint film of the surface treated steel sheet, then heating it to make the phenolic resin cross-link and bond the paint film and the outermost layer.

8. The method of production according to claim 7, the method comprising:
placing an electrodeposition coating film as the outermost layer on the surface of the paint film.
